(19) United States
(12) Patent Application Publication
(10) Pub. No.: US 2016/0012474 A1
(43) Pub. Date: Jan. 14, 2016

(54) METHOD AND SYSTEM FOR IDENTIFYING INFLUENCERS FROM TRANSACTION DATA

(71) Applicant: MasterCard International Incorporated, Purchase, NY (US)

(72) Inventors: Shubhra SRIVASTAVA, Scarsdale, NY (US); Serge BERNARD, Danbury, CT (US)

(21) Appl. No.: 14/330,402

(22) Filed: Jul. 14, 2014

(51) Int. Cl. G06Q 30/02; G06Q 40/00

(52) U.S. Cl. CPC G06Q 30/0246; G06Q 40/12

(57) ABSTRACT

A method for identifying linked payment accounts includes storing an account profiles related to payment accounts and storing transaction data for a plurality of payment transactions, each involving a payment account, a merchant, and each conducted at a specific time and/or date. Transaction pairs are identified for two transactions conducted within a predetermined period of time and involving the same merchant, but two different accounts. Sets of transaction pairs are then identified, with each set including at least transaction pairs that include the same two accounts. Those two accounts are then identified as linked payment accounts. A network of accounts may be identified based on payment accounts and their links to other accounts. Within the network, influencer accounts may be identified from accounts that conduct transactions with a merchant before others in the network, and follower accounts may be identified from accounts that follow influencers in transaction at merchants.

### FIELD

The present disclosure relates to the identification of linked payment accounts, specifically identifying payment accounts corresponding to an influencing consumer and an influenced consumer based on shared transaction history.

### BACKGROUND

Consumers may be influenced to visit specific merchants or buy specific products by a variety of people who others look to for guidance, referred to herein as influencers. Many merchants, advertisers, and other entities are often interested in figuring out what kind of information influences consumers, analyzing such information, and finding out how they can use the information to their advantage. For example, a consumer may be influenced to purchase a product after viewing a print advertisement for the product. The product's manufacturer or the developer/distributor of the print advertisement may find value in data regarding the advertisement's effectiveness, which may affect future advertisement designs or distributions.

However, while many methods and systems have been developed to measure the effectiveness of various types of influences, such as advertising, coupons or offers, consumer reviews, and the like, many methods and systems fail to identify, let alone measure, the effectiveness of other people in a consumer's social network. For example, a group of consumers that comprise a social network may include a particular person who keeps up with restaurant trends and influences others in the network to try certain restaurants.

Current methods and systems for identifying influences of a consumer are unable to identify other people in that consumer's network, let alone one of whom may be influencing the consumer. Identifying such an influencer may be more beneficial than identifying other influences for a consumer, as a merchant, advertiser, or content provider may be able to reach a large number of consumers by targeting a single influential person, while also realizing increased effectiveness of their targeting efforts if consumers are more influenced by their social network than other methods.

Thus, there is a need for a technical solution to identify payment accounts corresponding to consumers that are linked in a social network based on shared transaction history.

### SUMMARY

The present disclosure provides a description of systems and methods for identifying linked payment accounts.

A method for identifying linked payment accounts includes: storing, in an account database, a plurality of account profiles, wherein each account profile includes data related to a payment account including at least an account identifier; storing, in a transaction database, a plurality of transaction data entries, wherein each transaction data entry includes data related to a payment transaction including at least a transaction time and/or date, a merchant identifier associated with a merchant involved in the related payment transaction, and an account identifier corresponding to a payment account involved in the related payment transaction; identifying, in the transaction database, a plurality of transaction pairs, wherein each transaction pair includes two transaction data entries of the plurality of transaction data entries including a common merchant identifier, different account identifiers, and where the respective transaction times and/or dates are within a predetermined period of time; identifying, in the plurality of transaction pairs, at least one set of transaction pairs that includes at least a predetermined number of transaction pairs that include a common set of different account identifiers; and linking, for each set of transaction pairs, two account profiles in the account database, wherein each of the two account profiles includes an account identifier corresponding to an account identifier of the common set of different account identifiers in the respective set of transaction pairs.

A system for identifying linked payment accounts includes an account database, a transaction database, and a processing device. The account database is configured to store a plurality of account profiles, wherein each account profile includes data related to a payment account including at least an account identifier. The transaction database is configured to store a plurality of transaction data entries, wherein each transaction data entry includes data related to a payment transaction including at least a transaction time and/or date, a merchant identifier associated with a merchant involved in the related payment transaction, and an account identifier corresponding to a payment account involved in the related payment transaction. The processing device is configured to: identify, in the transaction database, a plurality of transaction pairs, wherein each transaction pair includes two transaction data entries of the plurality of transaction data entries including a common merchant identifier, different account identifiers, and where the respective transaction times and/or dates are within a predetermined period of time; identify, in the plurality of transaction pairs, at least one set of transaction pairs that includes at least a predetermined number of transaction pairs that include a common set of different account identifiers; and link, for each set of transaction pairs, two account profiles in the account database, wherein each of the two account profiles includes an account identifier corresponding to an account identifier of the common set of different account identifiers in the respective set of transaction pairs.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for identifying linked payment accounts in accordance with exemplary embodiments.

FIG. 2 is a block diagram illustrating the processing server of FIG. 1 for the identifying of linked payment accounts based on transaction data in accordance with exemplary embodiments.

FIG. 3 is a flow diagram illustrating a process for identifying linked payment accounts using the processing server of FIG. 2 in accordance with exemplary embodiments.

FIG. 4 is a diagram illustrating transaction data for a plurality of payment accounts and use thereof in identifying linked payment accounts in accordance with exemplary embodiments.

FIG. 5 is a flow diagram illustrating a process for identifying a network of consumers and an influencer in the network based on payment accounts linked using transaction data in accordance with exemplary embodiments.

FIG. 6 is a flow chart illustrating an exemplary method for identifying linked payment accounts in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Payment Account—A financial account that may be used to fund a transaction, such as a checking account, savings account, credit account, virtual payment account, etc. A payment account may be associated with a consumer, which is any entity using a payment account and may include a person, family, company, corporation, governmental entity, etc. In some instances, a payment account may be virtual, such as those accounts operated by PayPal®, etc.

### System for Linking Payment Accounts

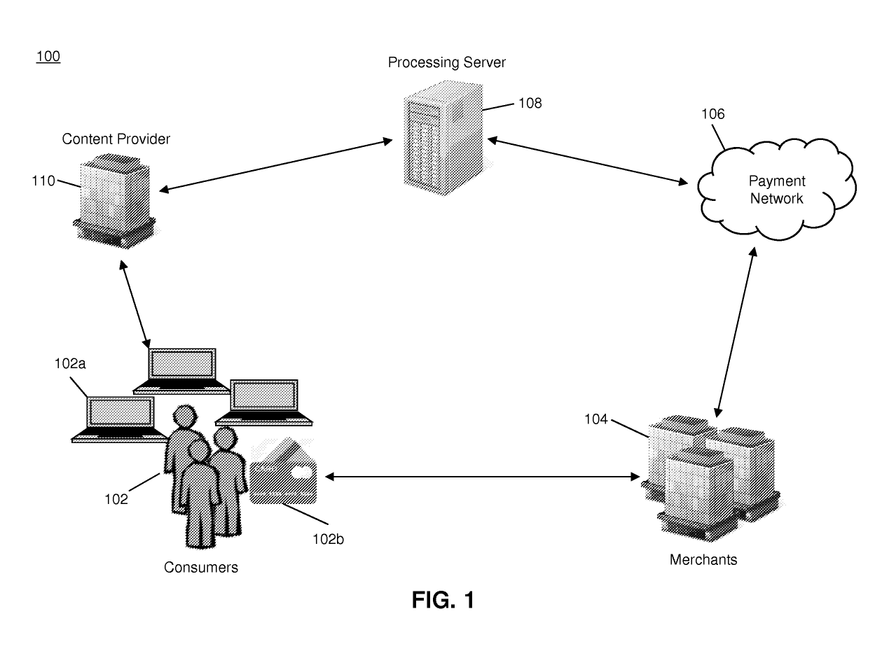

FIG. 1 illustrates a system 100 for linking payment accounts based on shared transaction history.

The system 100 may include a plurality of consumers 102. Each consumer 102 may be a member of a network of consumers. A consumer 102 may be involved in a plurality of payment transactions with one or more merchants 104, via computing devices 102a for being exposed to advertisements and by use of their payment cards 102b. Consumers 102 may be influenced to transact with merchants 104 by a variety of sources, including other consumers 102 in their network. For example, a first consumer 102 in a network may visit a specific merchant 104, such as a restaurant, and then may influence other consumers 102 to visit the same merchant 104 later in the week.

The system 100 may include a processing server 108. The processing server 108, discussed in more detail below, may be configured to identify links between consumers 102 in a network, and to further identify networks of consumers 102 and influential consumers 102 in a given network. The processing server 108 may identify links between consumers 102 via links in payment accounts associated with the respective consumers 102. Links between payment accounts may be identified by the processing server 108 using transaction history associated with each payment account.

Transactions conducted between consumers 102 and merchants 104 may be processed by one or more payment networks 106. The payment network 106 may be configured to forward transaction data for each payment transaction involving a consumer 102 and merchant 104 to the processing server 108. The transaction data may include at least a transaction time and/or date and information identifying each of the merchant 104 and consumer 102 involved in the corresponding payment transaction. The processing server 108 may receive the transaction data from the payment network 106 and store it in a transaction database, discussed in more detail below.

The processing server 108 may then identify linked payment accounts by identifying two payment accounts with a shared transaction history using the stored transaction data. As discussed in more detail below, the processing server 108 may identify pairs of transactions that include the same merchant 104, at least two different consumers 102, and that occur within a predetermined period of time of one another. The processing server 108 may then identify multiple transaction pairs that include the same two or more account numbers, which of course are associated with a consumer, or associate transaction pairs directly to consumers 102 if more than one account number is associated with at least one of the consumers 102 that have been matched by transaction pairs, with enough transaction pairs between two or more consumers 102 indicating that the two consumers 102 are part of a network. The processing server 108 may then identify a link between the payment accounts corresponding to each of the identified consumers 102.

In some instances, the processing server 108 may establish criteria for identifying transaction pairs. For example, the processing server 108 may identify transaction pairs for merchants 104 of specific merchant categories. For instance, the processing server 108 may not identify transaction pairs for payment transactions that involve gas stations or grocery stores, as such types of merchants may be regularly used by many consumers 102 that are not part of a network. In some instances, the processing server 108 may identify transaction pairs for a specific merchant category, such as restaurants, to identify a network of consumers 102 with regards to the specific merchant category. In such instances, a consumer 102 may be identified as a member of multiple networks. For example, one consumer 102 may be in a first network with respect to restaurants, and a second network with respect to clothing stores.

In some embodiments, the predetermined period of time used in the identification of transaction pairs may be based on one or more criteria, such as the merchant category associated with the respective merchant 104. For example, transaction pairs for restaurants may have a shorter predetermined period of time than transaction pairs for a car dealership.

In some instances, transaction pairs may also be further based on additional transaction data for the corresponding payment transactions. For example, transaction pairs may be identified for transactions having a similar transaction amount. In such an example, two transactions for a drastically different (e.g., outside of a predetermined amount, which may be based on the merchant 104 or other criteria) amount may not be identified as a pair. For instance, a $5 purchase at a clothing store by a first consumer 102 may not be linked with a $250 purchase at the same clothing store by a second consumer 102. In another example, transaction pairs may be based on product data included in the respective transaction data. For instance, a transaction pair may be identified only in instances where one or more products were purchased by both consumers 102. Additional data that may be used in the identification of transaction pairs will be apparent to persons having skill in the relevant art.

Networks of consumers 102 may be identified by identifying a plurality of payment accounts that are linked together. For example, the processing server 108 may identify a network of payment accounts where each payment account included therein is linked to at least two other payment accounts in the network. Methods for identifying a network of people or entities based on shared connections between the people or entities will be apparent to persons having skill in the relevant art.

The processing server 108 may be further configured to identify one or more influencers for a network. An influencer may be identified as a consumer 102 in a network of consumers based on their transactions with merchants 104 occurring before transactions with merchants 104 by other consumers 102 in the network. In some instances, influencers may be determined for specific merchant categories or other criteria. For example, the processing server 108 may identify a particular consumer 102 in a network as an influencer to others in the network when it comes to restaurants, but may identify a different consumer 102 in the same network as an influencer when it comes to clothing stores.

In some embodiments, the system 100 may include a content provider 110. The content provider 110 may be a merchant 104, an advertiser, an offer provider, a data reporting agency, or other suitable entity that may be interested in data regarding linked payment accounts, networks of consumers 102, or influential consumers 102. The content provider 110 may transmit a request for data to the processing server 108. The request for data may identify the type of data requested (e.g., linked accounts, network of consumers 102, influential consumers 102, a network of consumers 102 and its influencer(s), etc.) and may include one or more criteria regarding the requested data, such as a geographic area, period of time, or merchant category.

The processing server 108 may then identify linked payment accounts, networks of consumers 102, and/or influential consumers 102 based on the received request. Once the requested data is identified, it may then be provided by the processing server 108 to the content provider 110. The content provider 110 may thereby use the information, such as by targeting an influential consumer 102 in a network of consumers 102 with advertising.

In an example, the content provider 110 may request information regarding networks of consumers 102 and the two most influential consumers 102 in each network, for restaurants in a specified geographic area. The processing server 108 may then identify transaction pairs for transactions that involve merchants 104 that are restaurants in the specified geographic area. Once transaction pairs are identified, the processing server 108 may identify sets of pairs that include three or more transactions involving the same two consumers 102, and may link their corresponding payment accounts. The processing server 108 may then identify networks of consumers 102 that each include consumers 102 linked to two or more other consumers 102 in the network. The processing server 108 may identify the influencer in each transaction pair including consumers 102 in each network, and may then identify two consumers 102 in each network that are the influencer in the most transaction pairs. The processing server 108 may then transmit data regarding the identified networks and their influencers to the content provider 110.

Using shared transaction history may be an efficient and effective method for the processing server 108 to identify linked payment accounts, and to further identify networks of consumers 102 and influencers therein. In addition, by limiting criteria used for pairing transactions, the processing server 108 may be able to further increase the effectiveness and value of the data, such as by identifying networks of consumers 102 for specific categories, specific areas, and more. Such data may be useful for content providers 110 and other entities, including consumers 102, who may receive more personalized content from content providers 110 as a result.

### Processing Server

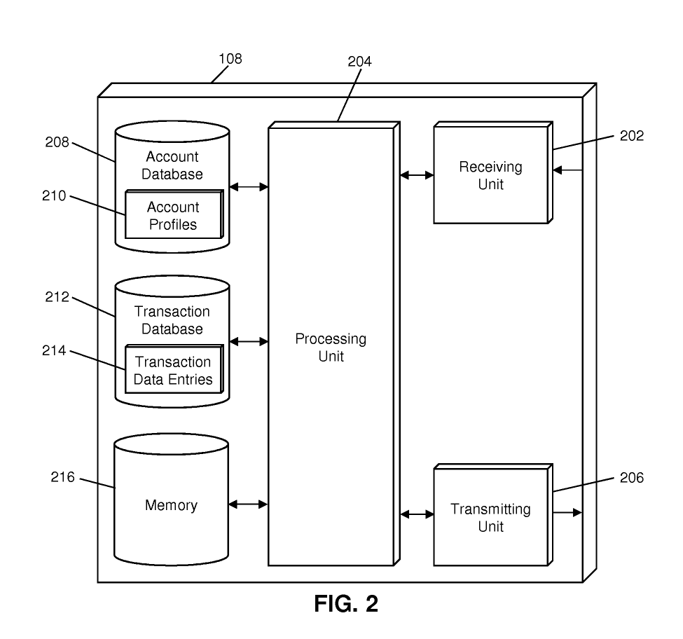

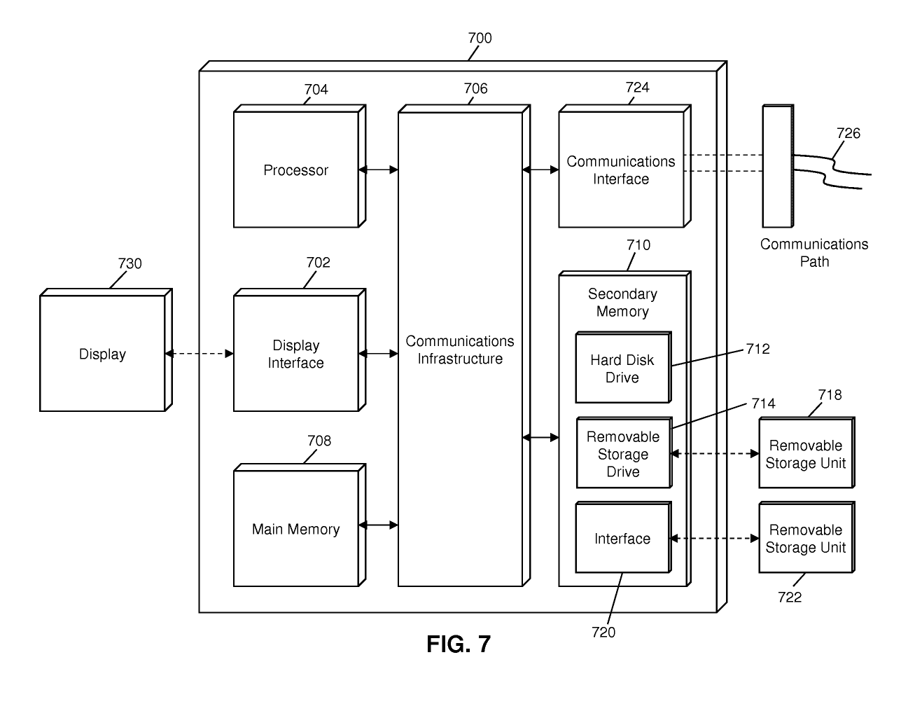

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 700 illustrated in FIG. 7 and discussed in more detail below may be a suitable configuration of the processing server 108.

The processing server 108 may include a receiving unit 202. The receiving unit 202 may be configured to receive data over one or more networks via one or more network protocols. The receiving unit 202 may receive data related to payment transactions from the payment network 106 for a plurality of payment transactions involving consumers 102 and merchants 104. The received data may be stored in a transaction database 212 as a plurality of transaction data entries 214.

Each transaction data entry 214 may include data related to a payment transaction including at least a transaction time and/or date, a merchant identifier, and an account identifier. The merchant identifier may be a unique value associated with a merchant 104 involved in the related payment transaction that may be suitable for identification of the associated merchant 104, such as an identification number, a point of sale device identifier, etc. The account identifier may be a unique value associated with a payment account or account profile corresponding to a consumer 102 involved in the related payment transaction. The account identifier may be an identification number, payment account number, phone number, e-mail address, username, or other suitable value as will be apparent to persons having skill in the relevant art.

In some instances, the transaction data entries 214 may include additional transaction data associated with the related payment transaction, such as for use in the identification of transaction pairs. For example, transaction data included in each transaction data entry 214 may include a transaction amount, a geographic location or location identifier, a merchant category, product data, coupon or offer data, or any other additional data that may be suitable for performing the functions disclosed herein as will be apparent to persons having skill in the relevant art.

The processing server 102 may also include an account database 208. The account database 208 may be configured to store a plurality of account profiles 210. Each account profile 210 may include data related to a payment account including at least an account identifier. The account identifier may be a unique value associated with the related payment account. The account identifier may be an identification number, payment account number, phone number, e-mail address, username, or other suitable value as will be apparent to persons having skill in the relevant art.

The processing server 108 may further include a processing unit 204. The processing unit 204 may be configured to perform the functions of the processing server 108 disclosed herein as will be apparent to persons having skill in the relevant art. The processing unit 204 may be configured to identify a plurality of transaction pairs of transaction data entries 214 stored in the transaction database 212. Each transaction pair may include two transaction data entries 214 that include a common merchant identifier (e.g., corresponding to a single merchant 104 or location of a merchant 104), different account identifiers (e.g., corresponding to two different account profiles 210 stored in the account database), and that include transaction time and/or dates within a predetermined period of time. In some embodiments, the predetermined period of time may be based on data associated with the common merchant identifier, such as a merchant category included in the transaction data entries 214 or otherwise associated with the merchant 104 corresponding to the common merchant identifier.

In some instances, the processing unit 204 may be configured to ignore (e.g., not include in transaction pairs) transaction data entries 214 that include predetermined merchant category data or other transaction data. For example, the processing unit 204 may not identify transaction pairs for payment transactions below a preset transaction amount (e.g., transactions for less than $5), for payment transactions involving gas stations or grocery stores, or for payment transactions in a specific geographic area, such as for payment transactions involving restaurants in a town with a limited number of restaurants that local consumers 102 may visit.

The processing unit 204 may be further configured to identify one or more sets of transaction pairs. Each set of transaction pairs may include at least a predetermined number of transaction pairs that include a common set of account identifiers. The predetermined number of transaction pairs may be set by the processing unit 204, may be included in a request for data (e.g., from the content provider 110), based on a strength of the included transaction pairs as determined by the processing unit 204 (e.g., where smaller transactions or transactions involving specific merchants 104 or merchant categories may be less indicative of a relationship than other transactions), and other additional criteria as will be apparent to persons having skill in the relevant art. For each set of transaction pairs, the processing unit 204 may be configured to identify the corresponding account profiles 210 in the account database 208 as being linked.

In some embodiments, the processing unit 204 may be further configured to identify a network of account profiles 210. Methods for identifying a network of items based on connections between items will be apparent to persons having skill in the relevant art. In one example, the processing unit 204 may identify a starting account profile 210, may then identify account profiles 210 linked to the starting account profile 210, then identify further account profiles 210 linked to those account profiles 210, etc., until a predetermined number of account profiles 210 have been identified, further account profiles 210 are not linked to any previously identified account profiles 210, etc.

The processing unit 204 may also be configured to identify one or more influencers in a network of account profiles 210. In such an embodiment, the processing unit 204 may identify an account identifier in each transaction pair involving account profiles 210 in the network as an influencer in the respective transaction pair, based on the transaction time and/or date included in the respective transaction data entry 214. For example, the influencer may be the account identifier of the account profile 210 that transacted with the involved merchant 104 first. The processing unit 204 may then order the account profiles 210 in the network by the number of transaction pairs for which the included account identifier has been identified as the influencer. In some embodiments, influencers may be identified with respect to individually linked account profiles 210. Additional methods for identifying influencers in a network based on shared transaction history will be apparent to persons having skill in the relevant art.

The processing server 108 may further include a transmitting unit 206. The transmitting unit 206 may be configured to transmit data over one or more networks via one or more network protocols. The transmitting unit 206 may transmit data, such as identified account profiles 210 and/or date included therein, in response to a request for data received by the receiving unit 202. When a request for data is received, the processing unit 204 may be configured to identify the data request, and may instruct the transmitting unit 206 to transmit the data in response to the received request, using methods and systems that will be apparent to persons having skill in the relevant art.

The processing server 108 may also include a memory 216. The memory 216 may be configured to store data suitable for performing the functions disclosed herein. For example, the memory 216 may store one or more rules for identifying transaction pairs (e.g., regarding merchant categories and predetermined periods of time or transaction amounts, predetermined numbers of transaction pairs required for sets, etc.), received data requests, account profile networks, and any other suitable data as will be apparent to persons having skill in the relevant art.

### Process for Identifying Linked Payment Accounts

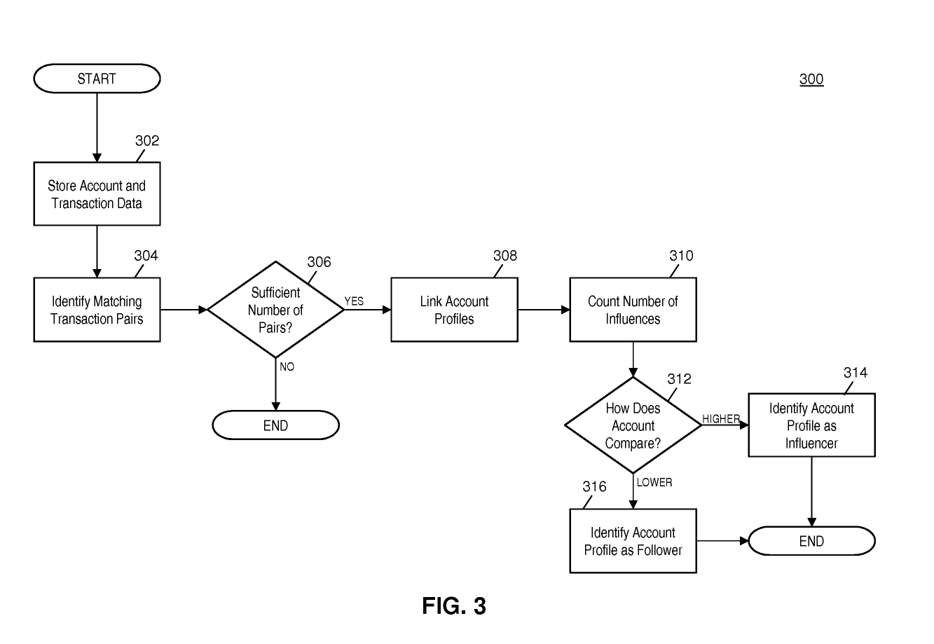

FIG. 3 illustrates a process 300 for identifying linked payment accounts and influencers thereof based on shared transaction history.

In step 302, the receiving unit 202 of the processing server 108 may receive transaction data for a plurality of payment transactions, and the processing unit 204 of the processing server 108 may store the received transaction data as transaction data entries 214 in the transaction database 212 of the processing server 108. The processing unit 204 may also store account profiles 210 in the account database 208 of the processing server, such that an account profile 210 exists in the account database 208 including an account identifier corresponding to each account identifier included in the received transaction data.

In step 304, the processing unit 204 may identify a plurality of transaction pairs. Each transaction pair may include two transaction data entries 214 stored in the transaction database 212 that includes a common merchant identifier, different account identifiers, and where the respective transaction times and/or dates are within a predetermined period of time. In some embodiments, the processing unit 204 may identify transaction pairs for specific merchant categories, for specific merchant identifiers, for transaction data entries 214 in a specific geographic area, of a minimum transaction amount, or within a predetermined range of amounts, or based on alternative or additional criteria.

In step 306, the processing unit 204 may identify sets of transaction pairs, where each transaction pair in each set of transaction pairs includes the same account identifiers, and may determine if a suitable number of transaction pairs are included in each identified set. The suitable number of transaction pairs may be a predetermined number that may be based on one or more criteria as will be apparent to persons having skill in the relevant art, such as the merchant category or categories of the included transaction data entries 214, strength of the included transaction pairs, etc. If there are not a sufficient number of transaction pairs in a set of transaction pairs, then the process 300 may be completed as no linkage may be found.

If, in step 306, the processing unit 204 determines that one or more sets of transaction pairs includes a sufficient number of transaction pairs, then, in step 308, the processing unit 204 may link the account profiles 210 corresponding to the account identifiers included in each set of transaction pairs in the account database 208. In step 310, the processing unit 204 may count the number of influences for each account profile 210 in each of the sets of transaction pairs that have been linked. The number of influences may correspond to the number of transaction pairs in which the respective account profile 210 is involved in the earlier payment transaction of the pair.

In step 312, the processing unit 204 may determine which of the two account profiles 210 in each set of transaction pairs has the higher or lower amount of influences compared to the other account profile 210 in the set. If an account profile 210 has a higher number of influences compared to the other account profile 210, then, in step 314, the processing unit 204 may indicate the account profile 210 as being influential over the linked account profile 210 in the account database 208. If the account profile 210 has a lower number of influences compared to the other account profile 210, then, in step 316, the processing unit 204 may indicate the account profile 210 as being a follower (e.g., influenced by) the linked account profile 210 in the account database 208.

### Identification of a Network of Consumers

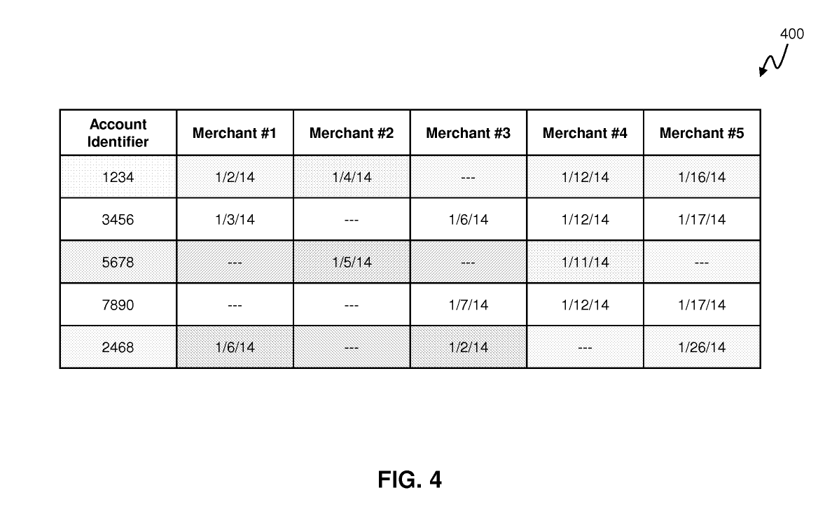

FIG. 4 is an illustration of a table 400 of transaction data suitable for use by the processing unit 204 of the processing server 108 for identifying a network of consumers 102 based on transaction pairs.

Each row in the table 400 may correspond to an account profile 210 stored in the account database 208, As illustrated in FIG. 4, the table 400 may include data for five account profiles 210, with the included account identifiers being 1234, 3456, 5678, 7890, and 2468, respectively. Each column of the table 400 may correspond to a merchant 104 involved in two or more payment transactions with the payment accounts corresponding to the five account profiles 210, illustrated in FIG. 4 as Merchants #1, #2, #3, #4, and #5.

Each of the account profiles 210 may correspond to a payment account involved in a payment transaction with two or more of the merchants 104. In instances where there has been a payment transaction involving an account profile 210 and a merchant 104, the corresponding cell in the table 400 may include a transaction data for the corresponding payment transaction (e.g., as included in the transaction data entry 214). For example, as illustrated in FIG. 4, the consumer 102 associated with account profile 210 having the account identifier 1234 may have transacted with Merchant #1 on Jan. 2, 2014, with Merchant #2 on Jan. 4, 2014, and Merchant #5 on Jan. 16, 2014.

The processing unit 204 may identify transaction pairs based on the data included in the table 400 and as discussed herein. In the example discussed herein, a transaction pair may include two transaction data entries 214 including a common merchant identifier, different account identifiers, and whose transaction dates are within one day of one another. As illustrated in FIG. 4, a transaction pair may be identified between the account profiles 210 corresponding to accounts 1234 and 3456 for their transactions with Merchant #1. In this transaction pair, the account profile 210 corresponding to account 1234 may be considered the influencer, as the corresponding transaction occurred before the transaction involving account 3456.

In the example discussed herein, the processing unit 204 may identify two accounts as being linked if the number of transaction pairs for the two accounts is at least three. In the example illustrated in FIG. 4, the processing unit 204 may thus identify that accounts 1234 and 3456 are linked and that accounts 3456 and 7890 are linked. Accounts 1234 and 5678 may not be linked, because the two accounts include only two corresponding transaction pairs. Account 2468 may not be linked with any other account, as it has no transaction pairs with other accounts, as each of its transactions are outside of the predetermined period of time with the other transactions.

In the illustrated example, the processing unit 204 may thus identify a network of consumers 102 including those consumers 102 associated with accounts 1234, 3456, and 7890 due to the linked payment accounts. Account 1234 may be identified as the influencer in the network. In the example illustrated in FIG. 4, account 1234 has the earliest transaction in both transaction pairs with account 3456, as well as the transaction pair with account 7890, while account 3456 is the influencer in only a single transaction pair with account 7890.

It will be apparent to persons having skill in the relevant art that the example illustrated in FIG. 4 and discussed herein for the identification of a network of consumers and influencers thereof based on shared transaction history is provided as an illustration only, and that the methods and systems discussed herein for the identification of linked payment accounts and networks and influencers thereof may include additional or alternative data and may use different criteria and/or values for identification of data therein, such as different predetermined periods of time, and predetermined numbers of transaction pairs.

### Process for Providing Network and Influencer Data

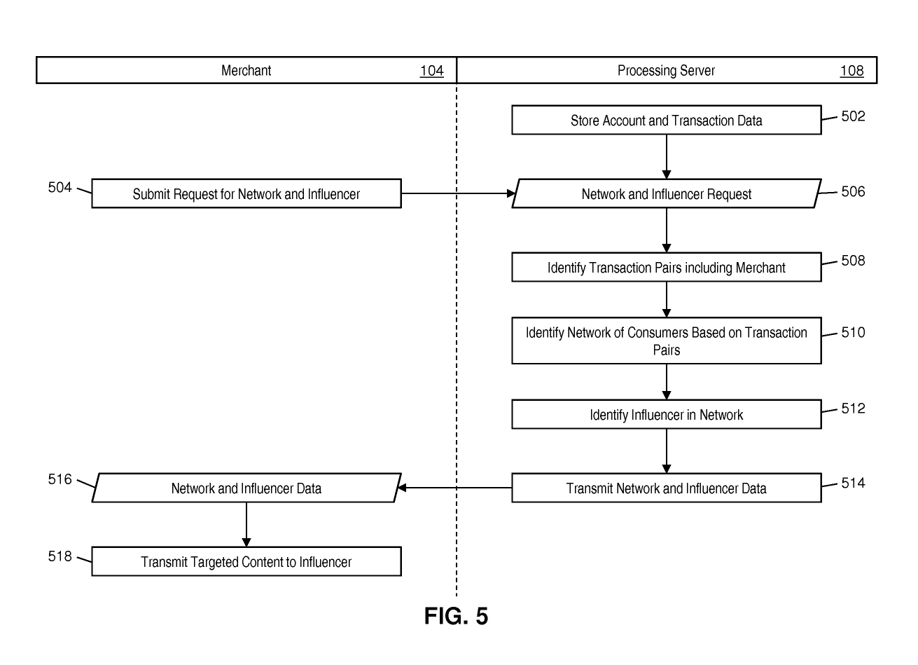

FIG. 5 illustrates a process for providing network and influencer data based on payment accounts linked using shared transaction history in response to a request.

In step 502, the processing server 108 may store transaction data entries 214 in the transaction database 212 and account profiles 210 in the account database 208. Each transaction data entry 214 may include at least a transaction time and/or date, a merchant identifier, and an account identifier corresponding to an account profile 210. In step 504, the merchant 104 (e.g., or other third party, such as the content provider 110) may submit a request for a network of consumers that shop at the merchant 104 and identification of an influencer in the consumer network. In some embodiments, the request may include additional criteria, such as a geographic area, merchant category, etc.

In step 506, the receiving unit 202 of the processing server 108 may receive the request. In step 508, the processing unit 204 of the processing server 108 may identify a plurality of transaction pairs, where each transaction pair includes two transaction data entries 214 including the merchant identifier corresponding to the merchant 104, two different account identifiers, and where the included transaction times and/or dates are within a predetermined period of time. The predetermined period of time may be set by the processing unit 204 (e.g., based on the merchant category of the merchant 104), or may be specified by the merchant 104, such as in the submitted request.

In step 510, the processing unit 204 may be configured to identify a network of consumers 102 based on the identified transaction pairs using the methods and systems discussed herein. In step 512, the processing unit 204 may identify an influencer in the network of consumers 102 based on the number of transaction pairs in which each consumer 102 in the network of consumers 102 is an influencer based on the transaction times and/or dates included in the respective transaction data entries 214. In some embodiments, the processing unit 204 may identify multiple influencers, such as a number of influencers specified in the request submitted by the merchant 104 and received in step 506.

In step 514, the transmitting unit 206 of the processing server 108 may transmit data regarding the identified network of consumers 102 and the identified influencer to the merchant 104. In step 516, the merchant 104 may receive the data. The data may include, for example, contact information (e.g., provided by the consumers 102 associated with each account profile 210), account identifiers, or other suitable data for each account profile 210 in the identified network, and an indication of one or more account profiles 210 in the identified network as being an influencer. Additional data that may be provided to the merchant 104 by the processing server 108 will be apparent to persons having skill in the relevant art. In step 518, the merchant 104 may distribute targeted content to the influential consumer 102 in the network, in an effort to reach both the influential consumer 102 and the rest of the network, due to the influential consumer's 102 position as an influencer in the network.

### Exemplary Method for Identifying Linked Payment Accounts

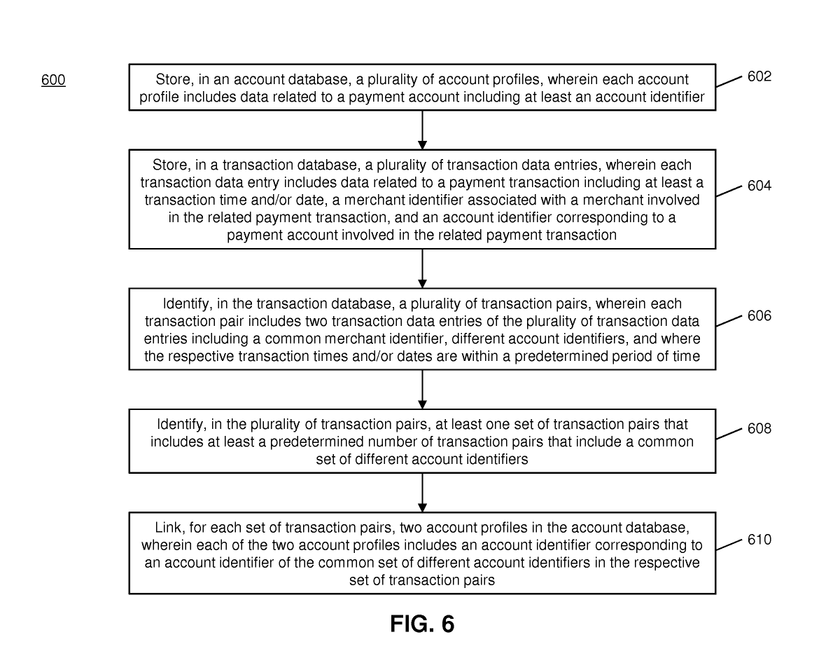

FIG. 6 illustrates an exemplary method 600 for the identification of linked payment accounts based on shared transaction history.

In step 602, a plurality of account profiles (e.g., account profiles 210) may be stored in an account database (e.g., the account database 208), wherein each account profile 210 includes data related to a payment account including at least an account identifier. In one embodiment, the account identifier may be an account number corresponding to the related payment account.

In step 604, a plurality of transaction data entries (e.g., transaction data entries 214) may be stored in a transaction database (e.g., the transaction database 212), wherein each transaction data entry 214 includes data related to a payment transaction including at least a transaction time and/or date, a merchant identifier associated with a merchant (e.g., the merchant 104) involved in the related payment transaction, and an account identifier corresponding to a payment account involved in the related payment transaction.

In step 606, a plurality of transaction pairs may be identified in the transaction database 212, wherein each transaction pair includes two transaction data entries 214 of the plurality of transaction data entries 214 including a common merchant identifier, different account identifiers, and where the respective transaction times and/or dates are within a predetermined period of time. In some embodiments, the predetermined period of time may be based on the merchant 104 associated with the common merchant identifier. In one embodiment, each transaction data entry 214 may further include a transaction amount, and the two transaction data entries 214 included in each transaction pair may include a transaction amount within a predetermined range of amounts. In a further embodiment, the predetermined range of amounts may be based on the merchant associated with the common merchant identifier.

In step 608, at least one set of transaction pairs may be identified in the plurality of transaction pairs that includes at least a predetermined number of transaction pairs that include a common set of different account identifiers. In one embodiment, each of the predetermined number of transaction pairs included in each set of transaction pairs includes a time and/or date within a predetermined range of time and/or dates.

In step 610, two account profiles 210 may be linked in the account database 208 for each set of transaction pairs, wherein each of the two account profiles 210 includes an account identifier corresponding to an account identifier of the common set of different account identifiers in the respective set of transaction pairs. In some embodiments, the method 600 may further include: receiving, by a receiving device (e.g., the receiving unit 202), a request for a consumer network, wherein the request includes at least a requesting criteria associated with at least one common merchant identifier; and transmitting, by a transmitting device (e.g., the transmitting unit 206), at least the network of account profiles in response to the received request for a consumer network.

In one embodiment, the method 600 may further include identifying, in the account database 208, a network of account profiles 210, wherein each account profile 210 in the network of account profiles 210 is linked to at least two other account profiles 210 included in the network of account profiles 210. In a further embodiment, the method 600 may even further include: identifying, for each account profile 210 in the network of account profiles 210, a number of influencing transactions based on a number of transaction pairs where one of the included transaction data entries 214 includes the account identifier included in the respective account profile 210 and a transaction time and/or date earlier than the transaction time and/or date included in the other transaction data entry 214 in the transaction pair; and identifying, in the network of account profiles 210, an influencer account profile 210 where the number of influencing transactions for the influencer account profile 210 is greater than the number of influencing transactions for other account profiles 210 in the network of account profiles 210. In an even further embodiment, the method 600 may also include indicating, in the identified influencer account profile 210, the account profile 210 as being an influencer in the identified network of account profiles.

### Computer System Architecture

FIG. 7 illustrates a computer system 700 in which embodiments of the present disclosure, or portions thereof, may be implemented as computer-readable code. For example, the computing devices 102a and the processing server 108 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 5, and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3, 5, and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for identifying linked payment accounts. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying linked payment accounts, comprising:
storing, in an account database, a plurality of account profiles, wherein each account profile includes data related to a payment account including at least an account identifier;
storing, in a transaction database, a plurality of transaction data entries, wherein each transaction data entry includes data related to a payment transaction including at least a transaction time and/or date, a merchant identifier associated with a merchant involved in the related payment transaction, and an account identifier corresponding to a payment account involved in the related payment transaction;
identifying, in the transaction database, a plurality of transaction pairs, wherein each transaction pair includes two transaction data entries of the plurality of transaction data entries including a common merchant identifier, different account identifiers, and where the respective transaction times and/or dates are within a predetermined period of time;
identifying, in the plurality of transaction pairs, at least one set of transaction pairs that includes at least a predetermined number of transaction pairs that include a common set of different account identifiers; and
linking, for each set of transaction pairs, two account profiles in the account database, wherein each of the two account profiles includes an account identifier corresponding to an account identifier of the common set of different account identifiers in the respective set of transaction pairs.

2. The method of claim 1, further comprising:
identifying, in the account database, a network of account profiles, wherein each account profile in the network of account profiles is linked to at least two other account profiles included in the network of account profiles.

3. The method of claim 2, further comprising:
identifying, for each account profile in the network of account profiles, a number of influencing transactions based on a number of transaction pairs where one of the included transaction data entries includes the account identifier included in the respective account profile and a transaction time and/or date earlier than the transaction time and/or date included in the other transaction data entry in the transaction pair; and
identifying, in the network of account profiles, an influencer account profile where the number of influencing transactions for the influencer account profile is greater than the number of influencing transactions for other account profiles in the network of account profiles.

4. The method of claim 3, further comprising:
indicating, in the identified influencer account profile, the account profile as being an influencer in the identified network of account profiles.

5. The method of claim 1, wherein each of the two transaction data entries in each of the predetermined number of transaction pairs included in each set of transaction pairs includes a transaction time and/or date within a predetermined range of time and/or dates.

6. The method of claim 1, wherein the account identifier is a payment account number corresponding to the related payment account.

7. The method of claim 1, wherein the predetermined period of time is based on the merchant associated with the common merchant identifier.

8. The method of claim 1, wherein
each transaction data entry further includes a transaction amount, and
the two transaction data entries included in each transaction pair include a transaction amount within a predetermined range of amounts.

9. The method of claim 8, wherein the predetermined range of amounts is based on the merchant associated with the common merchant identifier.

10. The method of claim 1, further comprising:
receiving, by a receiving device, a request for a consumer network, wherein the request includes at least a requesting criteria associated with at least one common merchant identifier; and
transmitting, by a transmitting device, at least the network of account profiles in response to the received request for a consumer network.

11. A system for identifying linked payment accounts, comprising:
an account database configured to store a plurality of account profiles, wherein each account profile includes data related to a payment account including at least an account identifier;
a transaction database configured to store a plurality of transaction data entries, wherein each transaction data entry includes data related to a payment transaction including at least a transaction time and/or date, a merchant identifier associated with a merchant involved in the related payment transaction, and an account identifier corresponding to a payment account involved in the related payment transaction; and
a processing device configured to
identify, in the transaction database, a plurality of transaction pairs, wherein each transaction pair includes two transaction data entries of the plurality of transaction data entries including a common merchant identifier, different account identifiers, and where the respective transaction times and/or dates are within a predetermined period of time,
identify, in the plurality of transaction pairs, at least one set of transaction pairs that includes at least a predetermined number of transaction pairs that include a common set of different account identifiers, and
link, for each set of transaction pairs, two account profiles in the account database, wherein each of the two account profiles includes an account identifier corresponding to an account identifier of the common set of different account identifiers in the respective set of transaction pairs.

12. The system of claim 11, wherein the processing device is further configured to identify, in the account database, a network of account profiles, wherein each account profile in the network of account profiles is linked to at least two other account profiles included in the network of account profiles.

13. The system of claim 12, wherein the processing device is further configured to
identify, for each account profile in the network of account profiles, a number of influencing transactions based on a number of transaction pairs where one of the included transaction data entries includes the account identifier included in the respective account profile and a transaction time and/or date earlier than the transaction time and/or date included in the other transaction data entry in the transaction pair, and
identify, in the network of account profiles, an influencer account profile where the number of influencing transactions for the influencer account profile is greater than the number of influencing transactions for other account profiles in the network of account profiles.

14. The system of claim 13, wherein the processing device is further configured to indicate, in the identified influencer account profile, the account profile as being an influencer in the identified network of account profiles.

15. The system of claim 11, wherein each of the two transaction data entries in each of the predetermined number of transaction pairs included in each set of transaction pairs includes a transaction time and/or date within a predetermined range of time and/or dates.

16. The system of claim 11, wherein the account identifier is a payment account number corresponding to the related payment account.

17. The system of claim 11, wherein the predetermined period of time is based on the merchant associated with the common merchant identifier.

18. The system of claim 11, wherein
each transaction data entry further includes a transaction amount, and
the two transaction data entries included in each transaction pair include a transaction amount within a predetermined range of amounts.

19. The system of claim 18, wherein the predetermined range of amounts is based on the merchant associated with the common merchant identifier.

20. The system of claim 11, further comprising:
a receiving device configured to receive a request for a consumer network, wherein the request includes at least a requesting criteria associated with at least one common merchant identifier; and
a transmitting device configured to transmit at least the network of account profiles in response to the received request for a consumer network.
